(19) United States
(12) Patent Application Publication
(10) Pub. No.: US 2008/0050711 A1
(43) Pub. Date: Feb. 28, 2008

(54) Modulating Computer System Useful for Enhancing Learning

(76) Inventors: Jayfus T. Doswell, Alexandria, VA (US); Edward Hill, Leesburg, VA (US)

Correspondence Address: Robert M. DeWitty, Esq., 111 S. Calvert Street, Ste. 2700, Baltimore, MD, 21202, US

(21) Appl. No.: 11/463,119

(22) Filed: Aug. 8, 2006

(51) Int. Cl. G09B 3/00

(52) U.S. Cl. 434/350

(57) ABSTRACT

The present invention relates to a system for enhancing the learning of a student, where such system contains a memory with a stored program, a user interface, a processor, and a power source, wherein the program contains one or more codified pedagogical principles. A method for teaching a student is also taught, whereby a scenario from a program is generated, interaction with the student is facilitated, feedback is delivered to the program, the feedback is analyzed, another scenario is generated wherein further scenarios are modified using codified pedagogical principles.

This application claims priority to provisional application 60/705,486 filed Aug. 5, 2005.

### BACKGROUND

The present system relates to systems for teaching using pedagogical principles incorporated into software programs, such software programs to be interactively utilized by the user.

“Pedagogy” is commonly defined as the science, art, theory, and practice of teaching. Andragogy, a subset of pedagogy, is the art and science of helping adults learn. Educators are mindfully focused on improving the learning environment for students. Theories for learning can be placed on a line graph, with “meaningful learning” theories at one end and “rote learning” techniques at the other. Meaningful learning occurs when individuals relate new knowledge to concepts and propositions they already know. Rote learning may be acquired by verbatim memorization and incorporating such into the knowledge structure without interacting with already possessed knowledge. Pedagogical principles center on education being dependent on the ability of a person to leverage from past experiences, and thus increase their knowledge. Teachers have utilized pedagogical principles to transform the field of teaching into a profession.

Incorporating technology into a learning environment can increase productivity. However, matching the technology capability with the learning objectives is important to productivity. Technology that is student centered and requires active engagement on the part of the student can lead to high levels of enhanced learning. The environment for learning may also affect the learning productivity level, which may be enhanced with mixed reality environments. Mixed reality may be thought of as a continuum along a real to digital environment, where the environments are a Real Environment, an Augmented Reality, an Augmented Virtuality, and a Virtual Environment. In Augmented Reality, digital objects are added to real-world objects. In Augmented Virtuality, real objects are added to virtual ones. In Virtual Environment (or virtual reality), the surrounding environment is virtual. Virtual Reality (VR) refers to a three-dimensional simulated environment created by the use of specifically configured computer software and hardware. In virtual reality, users can interact with and manipulate 3 dimensional (3D) graphical objects.

Previous systems have used Reality and Virtual Reality environments while emphasizing Rote Learning techniques for teaching students. The patent to Holland et al. (U.S. Pat. No. 5,454,722) teaches an interactive computer system to be used for training persons in surgical procedures. Whereas the user's knowledge about a specific procedure may be tested by the system, the system does not contain pedagogical principles incorporated within the program to program teaching techniques specific to users and thus enhance their learning.

The patent to Eggert et al. (U.S. Pat. No. 6,503,087) teaches an interactive education system for teaching patient care. Whereas feedback is provided, there is no indication that the system is adjusted based on the learning style particular to the user.

The patent to Eggert et al. (U.S. Pat. No. 6,758,676) relates to an interactive education system for teaching patient care. Whereas a test can be designed to avoid rote memorized responses by the student, the system does not allow for modification based on the learning style particular to pedagogical standards, and therefore the user's learning is not fully enhanced.

In the field of obstetrics, during delivery of a baby, information on the status of the baby during delivery is currently obtained using cardiotography (CTG) generated from electronic fetal monitor, scalp pH, pulse oximetry, or a combination of these techniques. Unfortunately, CTG interpretation has not been standardized in the industry. The lack of a standardized method of interpreting CTG has led to missed adverse intrapartum events. The failure to recognize abnormal CTG by nurses is the result of current training methods for CTG interpretation. The training methods fail to provide realistic clinical problems and case scenarios. Upon completion of the training, the novice practitioner or nurse may continue to misread abnormal CTG because of the lack of realistic training.

It is an object of the present system to overcome these and other disadvantages in the prior art.

### Specification

The present system proposes the incorporation of codified pedagogical principles into a program to be interactively used by a user, such codified pedagogical principles enhancing the knowledge of the user. Through the incorporation of pedagogical principles, a learning scenario can be modified to meet or more closely match the learning style of the user. When used in conjunction with a particular data, the knowledge of the user will be enhanced. The user interactively uses the program in a graphically digitized environment.

The present system includes a memory with a program stored therein, a user interface, a processor and a power source, wherein the program contains one or more codified pedagogical principles.

It should be expressly understood that the drawings are included for illustrative purposes and do not represent the scope of the present system. In the accompanying drawings, like reference numbers in different drawings may designate similar elements.

As a person with ordinary skill in the art will realize, the term “feedback” as used herein relates to information and responses received back from a user or student during use of the present system and in response to a scenario. Information and responses may be verbal communication, non-verbal communication, hand signals, body signals, involuntary movements, bodily measurements, a user's thought patterns, etc.

The term “virtual instructor” refers to an anthropomorphic digitized entity image that can be a human interactive 2D/3D animated character, robotic system, or a digital toy. Virtual instructors may be created from historical figures, mythological figures, contemporary figures, cartoon figures, and non-human entities.

The term “learning style” refers to the levels of the Visual, Auditory, Kinesthetic learning preferences of the student.

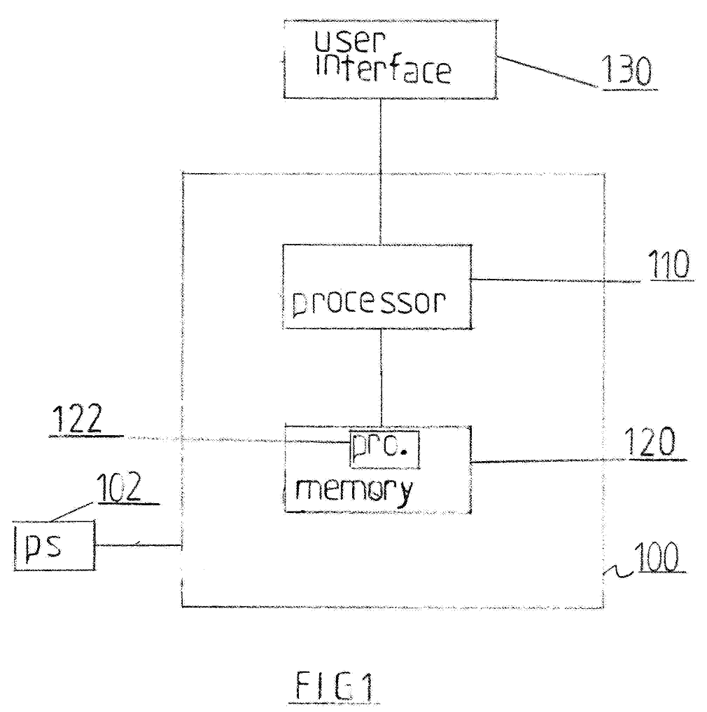

FIG. 1 shows the present system for teaching a student.

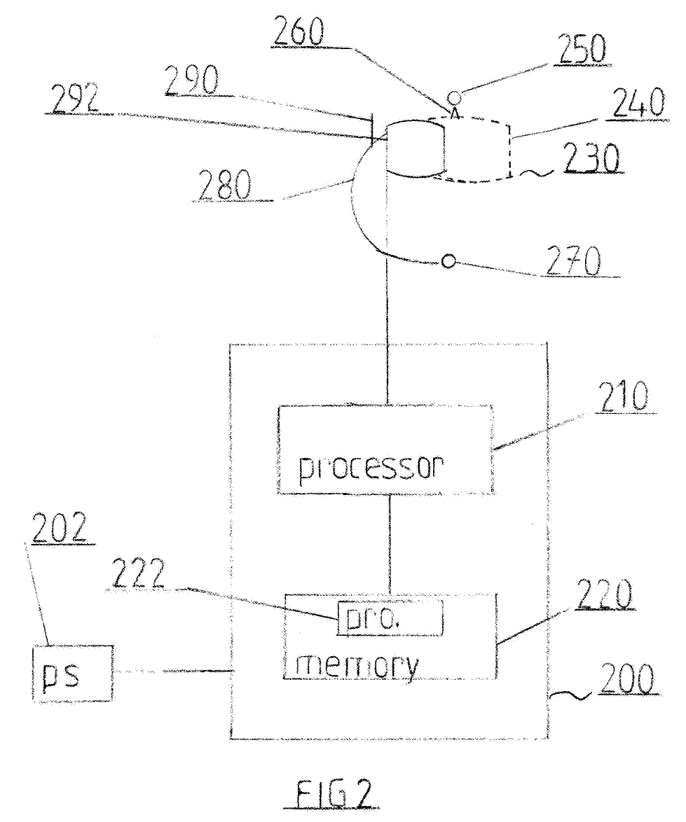

FIG. 2 shows an embodiment of the present system wherein the user interface is a electronically enabled goggles.

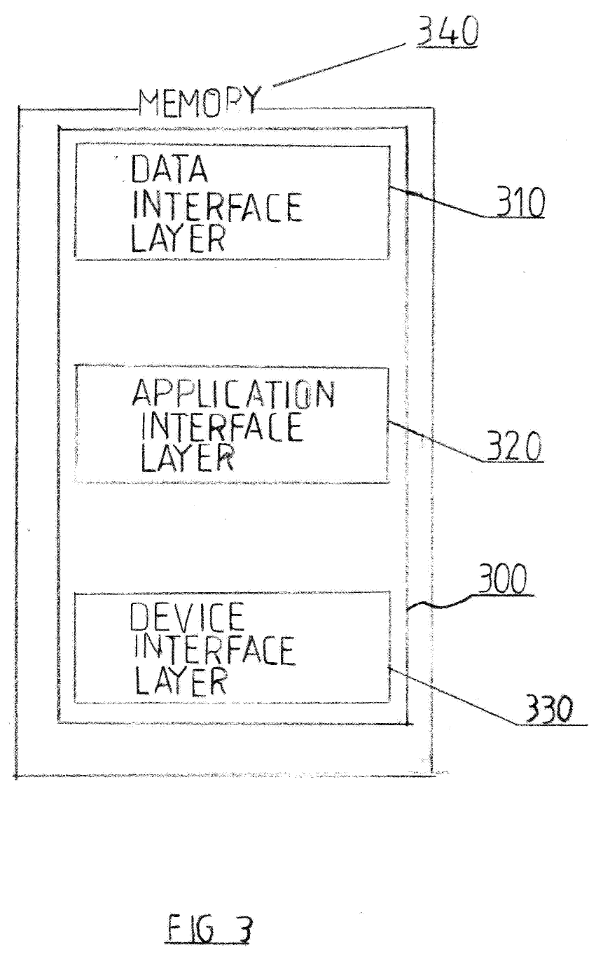

FIG. 3 is an embodiment of the program as used in the present system.

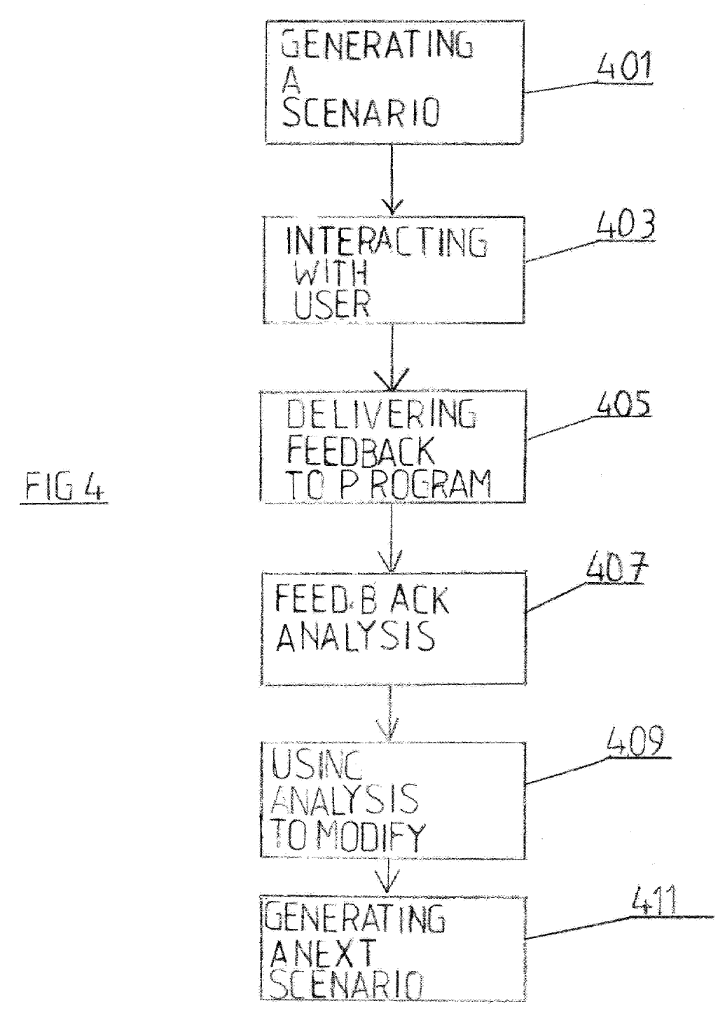

FIG. 4 is a method of the teaching a student utilizing the present system.

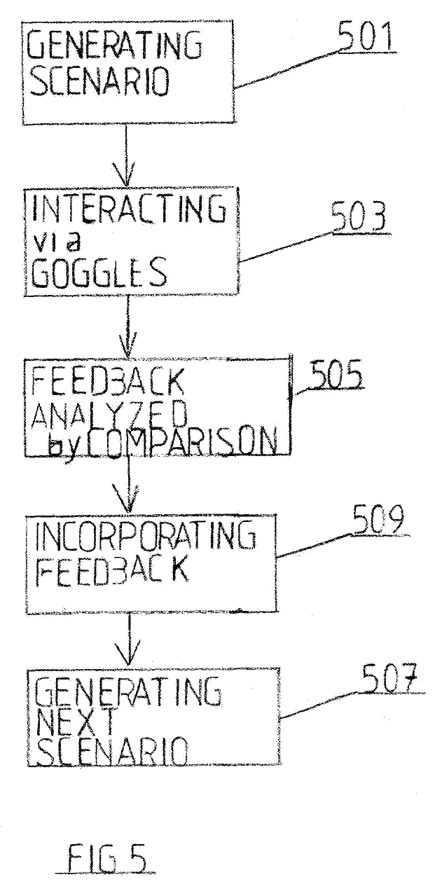

FIG. 5 is an embodiment of the method of teaching a student with the present system.

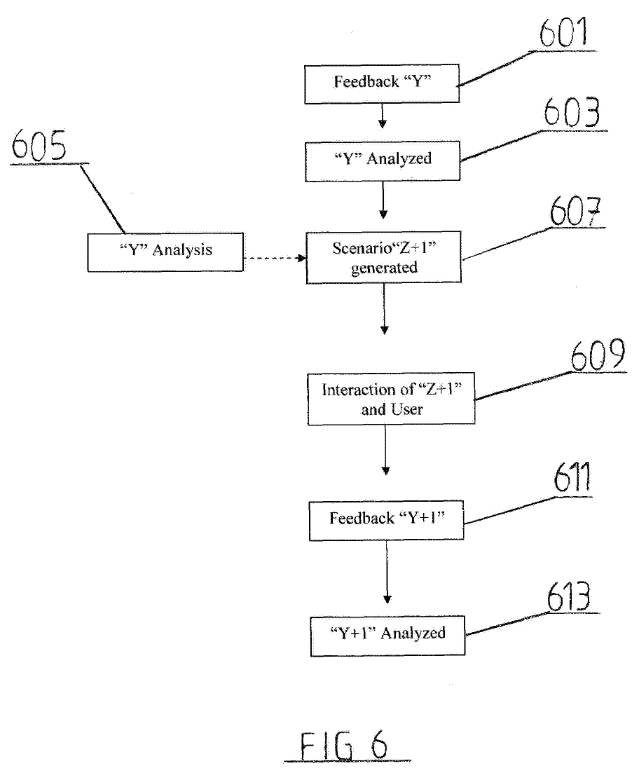

FIG. 6 is an embodiment of the present system exhibiting how the analysis of feedback from the user affects generated scenarios.

Referring to FIG. 1, a system 100 includes a power source 102, a processor 110 operationally connected to a memory 120 wherein a program 122 with codified pedagogical principles is contained therein. A user interface 130 is used to facilitate communication between the user and the system 100.

In the system 100, the processor 110 is capable of hosting an interactive environment for the user, for example an augmented virtuality, virtual reality, or mixed reality environment. The presentation of scenarios including questions, riddles, quizzes, tests, postulations, role play, tasks, procedures, and physical challenges, to the user can occur within the environment. Scenarios are preferably presented by a virtual instructor, which provides personalized instruction by following codified pedagogical principles. The acceptance of feedback such as answers, inputs, bodily measurements, and adjustments to the system from the user can occur within the environment. Modifications of future scenarios to meet the needs of the user, and upgrading to various levels to meet the needs of the user can also occur within the environment. The Processor 110 in the present system can include microprocessor, microcontroller, programmable digital signal processor or other programmable device. A processor can also include an application specific integrated circuit, a programmable gate array programmable array logic, a programmable logic device, a digital signal processor, an analog-to-digital converter, a digital-to-analog converter, or any other device that may be configured to process electronic signals. In addition, a processor may include discrete circuitry such as passive or active analog components, including resistors, capacitors, inductors, transistors, operational amplifiers, and so forth, as well as discrete digital components such as logic components, shift registers, latches, or any other separately packaged chip or other component for realizing a digital function. Any combination of the above circuits and components, whether packaged discretely, as a chip, as a chipset, or as a die, may be suitable adapted to use as a processor as described herein. Where a processor includes a programmable device such as the microprocessor or microcontroller mentioned above, the processor may further include computer executable code that controls operation of the programmable device.

Connected to the processor 110, the memory 120 is used for delivering data to the program 122 and storing data found in the feedback. The memory 120 can include read-only memory, programmable read-only memory, electronically erasable programmable read-only memory, random access memory, dynamic random access memory, double data rate random access memory, Rambus direct random access memory, flash memory, or any other volatile or non-volatile memory.

The memory 120 can contain program 122 code, stored program 122 instructions, program 122 data, and program 122 output or other intermediate or final results. The memory 120 also contains stored data, such as historical biological readings, including pulse/heart rate, body temperature, brain activity, eye movement, body gestures, ultrasound profile, fetal distress monitor traces, cardiotography (CTG) generated from electronic fetal monitor, scalp pH, pulse oximetry, etc., or combinations of data. The memory 120 may also have stored multiple scenarios such as questions, riddles, quizzes, tests, postulations, and physical challenges. Details of graphically digitized environments in augmented reality, augmented virtuality, virtual reality, or mixed reality format may also be included in the memory 120, such as digitized classrooms, digitized operating rooms, digitized laboratories, digitized hospitals, digitized offices, digitized worksites, etc. Such digitized environments could include information on room size, room temperature, room lighting, implements contained within the room, persons present in the room, graphical objects, and other specifics necessary to adequately describe the digital environment. Virtual reality can refer to a two dimensional, three dimensional, or four dimensional simulated environment. In a presented scenario, users of the system 100 can interact with and manipulate graphical objects. The scenarios may be presented in text, audio, video, 2-dimensional images, 3-dimensional images, pictures, paintings, graphical pictures, and movies, such scenarios being presented singly or in combination of two or more.

As will be discussed later, the program 122 contains codified pedagogical principles that allow a scenario to be modified to match the learning style of the user. Modification may occur in real-time, or in advance prior to the presentation of a scenario. The program 122 contains an architectural structure of one or more layers, each layer being represented by its own algorithmic code, and purpose. Layers may include a device interface layer, an application interface layer, a data interface layer, and a wireless network layer. The program contains two or more layers in combination.

The program 122 is suitable for collecting data, initiating scenarios, facilitating data exchange, and allowing wired and/or wireless transmission of data.

A user interface 130 may be used to facilitate communications between the user and the processor 110, upon which the scenario is running. The user interface 130 may be used to select a scenario from the memory 120, modify the scenario, select data for inclusion in the scenario, modify a scenario parameter, initiate the scenario, initiate an aspect of a scenario, design a new scenario, or provide other user interface solutions. As stated, the user interface 130 allows the user to interact with scenarios. The user interface 130 also allows the user to provide feedback.

A number of user interfaces 130 may be provided for use with the system 100, for example, mouse, keyboard, visual screen, display, touchscreen, voice command recognition, pointer system, electronically enabled goggles, biosensors, robotic systems, electronically enabled headbands, electronically enabled wristbands, electronically enabled gloves, electronically enabled glasses, personal devices such as cellular phones, mobile phones, or PDA's. “Electronically enabled” means interfaces that can contain electrical components, electronics components, digital components, a power source, wireless components, communication means such as antennas, microphones, cameras, etc.

User interfaces may also include biosensors. Biosensors may be worn in the clothing of the user or implanted in the human body. Biosensors are suitable for transmitting biological data from the users of the system, such as pulse rate/heart rate, body temperature, brain activity, eye movement, body gestures, etc. Biosensors may be used singly, or in an array of 2 or more. Biosensors may include wired or wireless communication means. Biosensors can be used with other physical sensors, such as video, EEG, MRI, transcranial magnetic stimulator, gyroscope, accelerometer, temperature gauges, and physiological determinants.

The user interfaces 130 may be used single, or in combination with each other of two or more. The user interface 130 may operate with or communicate with the processor by wired means, or by wireless means such as infrared, wireless fidelity (wifi), LAN, WLAN, or telecommunication means.

The user interface 130 may include a separate power source such as batteries, an electrical socket connection, or a USB connector which allows the user interface to derive its power from the system 100 or another source such as a computer.

The system 100 itself may include a power source 102, such as batteries, an electrical socket connection, or solar power cells.

FIG. 2 is an embodiment of the present system 200, including a power source 202, a processor 210 operationally connected to a memory 220 with a program 222, and electronically enabled goggles 230 as the user interface.

In the system 200, the processor 210 is connected to the memory 220 and the electronically enabled goggles 230. The memory 220 contains the program 222 possessing codified pedagogical principles. The pedagogical principles allow scenarios presented to the user to be modified based upon the learning style of the user. The program 222 stored on the memory 220 may consist of one or more layers, each layer being represented by its own algorithmic code. Layers may include a device interface layer, an application interface layer, a data interface layer, and a wireless network layer.

The electronically enabled goggles 230 can be a display 240 with a power source 280, a microphone 270, an antenna 290, a gyroscope 250, and a camera 260. The display 240 can be an extendable, optical see-through. The microphone 270 is capable of extending to the area of the mouth of the user. The antenna 290 can be useful for wireless communication with the computer. The gyroscope 250 is suitable for tracking the head and/or body position of the user. The camera 260 is suitable for viewing and recording physical objects surrounding the user. Biosensors can also be incorporated within the goggles 230.

The electronically enabled goggles 230 may communicate with the system 200 wirelessly via wireless fidelity (wifi), LAN, WLAN, telecommunication, or wired through cables.

In use, the program 222, using data stored on the memory 220, is used to generate scenarios including a graphical environment, questions, riddles, quizzes, tests, postulations, role play, and/or physical challenges. The digital environment may be an augmented reality, augmented virtuality, virtual reality, or mixed reality environment. Through the electronically enabled goggles 230, the user addresses the scenario, and provides feedback in the form of an answer, action, question, etc. The program 222 then generates another scenario, such scenario modified by the codified pedagogical principles found on the program 222 and the user's previous feedback.

FIG. 3 is an illustration of the architecture of the program 300 used in the present system, including a data interface layer 310, an application interface layer 320, and a device interface layer 330.

Being situated on the memory 340, the program 300 is used for organizing data on the memory 340, allowing the user to select data from the memory 340, allowing the user to customize scenarios, and allowing general control, modification, and manipulation of the system.

The data interface layer 310 includes one or more databases which contain information such as historical data, geographically-specific data, nationwide data, industry specific data, race or gender specific data, and contemporary or current data. The data interface layer 310 may also include data useful for the creation of a graphically digitized environments, such as a virtual reality environment, an augmented reality environment, or a mixed reality environment. Data useful for the creation of graphically digitized environments includes room size, room temperature, room lighting, room implements, room structure, etc. Additionally, the data interface layer 310 collects and stores information specific to each user of the present system, such as feedback to scenarios, and the analyzed learning style of the user. The information stored in the databases of the data interface layer 310 can be used as the subject matter of a scenario presented to the user.

The application interface layer 320 can include one or more algorithms, including algorithms suitable for processing a graphically digitized environment such as a virtual reality environment, an augmented reality environment, an augmented virtuality environment, or a virtual environment. Hosting a graphically digitized environment includes having the capability to visually present the graphically digitized environment.

Most notably, the application layer 320 contains algorithms of codified pedagogical principles. Pedagogical principles to be codified and placed into algorithms of the program 300 can include, for example;
Scaffolding, which is a method that provides a scaffold (i.e., crutch) for guiding learners, step by step, through the knowledge acquisition process towards independent application. This method consistently measures the learners feedback and then gradually removes the scaffold as the learner exemplifies acquired knowledge. In one example, a scaffolding pedagogy is applied to teach an auto-manufacture worker how to perform a wire harness assembly task. Explicit step by step instructions may be provided to guide the learner how to complete each procedure in the task. As the learner demonstrates understanding through variations of this exercise, guidance will be gradually removed until the learner is confident about performing the task on his/her own;
Weighted Multi-Modal Instruction, which is a method that tailors visual, auditory, kineshetic, and olfactory multi-modal cues to the respective learning strengths of the user in a weighted format. This method analyzes the weighted learning style of the learner and may, for example, assess than the learner is 60% visual,10% kinesthetic, 10% olfactory, and 20% auditory. The instructional method will then leverage these known learning style weights and match relevant multi-modal cues to accelerate learning of a particular concept;
Personality Based Instruction, which is a method of instruction whereby training is delivered based on the learner's personality (e.g., introverted or extroverted). For example, if the learner is introverted the instructional method will facilitate a independent learning experience. If the learner is extroverted, the instructional method may facilitae a learning experience with other learners (i.e., collaborative learning); and
Culturally Tailored Instruction, which is a method of instruction where instruction is personalized to the learner's culture background. For example, if the learner is African American and is learning about concepts of agriculture, this instructional method may deliver George Washington Carver as an animated character (e.g., virtual instructor) to instruct the learner basic concepts of Agriculture and many uses of the peanut.

The codified pedagogical principles can be presented in a mathematical equation or formulation, provided that they allow for the inclusion of feedback from the user, and then are able to modify the next scenario such that it is more closely aligned with the user's learning style. This modification utilizing the codified pedagogical principle will continue throughout a user's session, with each corresponding scenario more tailored to the student's needs and learning style.

An example of a codified pedagogical principle would be Scaffolding as codified using a “Logical_Test; If_True; If_False” function. In its codification, each and every possible feedback (read: response or answer) to a given scenario within a particular subject area would be given a “TRUE” value or a “FALSE” value. As a user interacts with a scenario and provides feedback, the feedback would be analyzed. Comparing the “TRUE” values against the “FALSE” values would allow the program to determine the well-known ideas held by the user, and which ideas are new. Future scenarios would continue to be modified in real-time to match the knowledge base and needs of the user. Thus, the user would enhance his knowledge.

Different mathematical functions may be utilized to codify the pedagogical principles, such as SUM (number 1, number 2, . . . ), AVERAGE (number 1, number 2, . . . ), MAX (number 1, number 2, . . . ), SUMIF (range, criteria, sum-range), etc.

In one embodiment, the program 300 contains several different codified pedagogical principles. The codified pedagogical principles may be of one function, or several different functions. In such an embodiment, the several scenarios are first presented to the user. The scenarios may cover the same subject matter. Based on feedback received from the user, the feedback that satisfied a particular pedagogical principle will allow more scenarios to be presented based on that principle. In this way, the learning style of the user is being met, as well as his knowledge base being enhanced.

The application interface layer 320 may also contains algorithms for issuing scenarios, algorithms for measuring the data and communication received from the user, algorithms for modulating the scenarios, and algorithms containing codified pedagogical principles. Algorithms relating to mixed reality environments, fetal monitor challenges, instructional exercises, and measurements may also be included in the application interface layer 320.

The device interface layer 330 can consist of algorithms suitable for transmitting scenarios, data, information, and bioinformation, and collecting feedback, data, information and bioscans.

The program 300 contains algorithms allowing the data interface layer 310, the application layer 320, and the device interface layer 330 to communicate with one another through the acceptance and passage of scenarios, data, bioinformation, and bioscans. Alternatively, the program 300 may also comprise a wireless network layer, such wireless network layer including algorithms that allow the transmission of data via wireless means between the various layers of the program 300, and/or between the program 300 and the user interfaces. The wireless network layer can include global system for mobile communications (GSM), personal digital cellular (PDC), universal wireless communications 136 (UWC-136), code division multiple access (CDMA), global system for mobile communications/general packet radio service (GSM/GPRS), and universal mobile telecommunications system.

FIG. 4 shows the method of teaching using the present system.

A scenario is generated 401 by the program and presented to the user. The scenario presented to the user may be a question, riddle, quiz, test, postulation, or physical challenge. The scenario may also include a graphically digitized environment, for example a virtual environment or a mixed reality environment. The scenario may also include implements, such as digital tools. The scenario may be generated from historical data, contemporary data, patient data, or a compilation of data selected by the user from the memory. The scenario is generally generated from an algorithm on the program, and presented to the user via the processor. The scenario may include a combination of the above in order to create a complete environment for the user. The scenario may be generated digitally, audio, in three-dimensional, in writing, or a combination of such.

Interaction with the user is then facilitated via the user interfaces 403. Interaction can occur in a graphically digitized environment, such as a virtual environment or mixed reality environment. Interaction between the scenario and the user can occur via answering questions, performing a specific task, asking a question, and/or selecting a variety of choices. Interaction can be verbal, non-verbal, and/or bodily measurements. Non-verbal communication can include hand-signals. Biosensors may also be used to provide feedback, including measurements relating to body temperature, brain waves, eye movement, sweat glands, increase or decrease of hormone levels, tensing and relaxing of muscle, blood pressure, stress levels etc. Interaction can occur verbally, non-verbally, and bodily measurements simultaneously. Interaction between scenario and user 403 results in feedback.

The feedback from the user is delivered to the program 405. Delivery can occur through wired means, such as physically connected wires, or wireless means, including WLAN, LAN, internet communications, VOIP, or network. The feedback is delivered to the device interface layer of the program and then to the application interface layer.

The feedback is then analyzed 407 by the program at the application interface layer. Analyzation of the feedback may occur by giving it a value, for example “TRUE” or “FALSE”. Feedback may also be given a numerical value. In such a way, feedback may be compared to previously stored data in order to determine if the feedback is “right” or “wrong” when compared to the previously stored data. Previously stored data may be on the memory of the system (not shown). In an embodiment, the feedback may be organized into several categories created in program. Analysis may occur by comparing the categories against one number in terms of the number of responses in each category. Analysis may also occur by comparing the user's bodily movement data to recorded movements stored on the memory. Analysis of the user's body signals may also occur by comparison with recorded body signals. Current user feedback can be compared with ‘standard’ or correct data stored on the system's memory. An instructor or other person may store ‘standard’ or correct data on the memory of the system. User feedback can also be compared with previous users data stored on the system's memory. User feedback may also be compared with historical data stored on the system's memory.

A next scenario will then be generated 409 by the program.

Results of the feedback analysis will then be used by the program to modify the next scenario 411, i.e., depending on the user's performance on the previous scenario, the next scenario generated will be presented in a way that is more suitable for the user's learning style, and the data contained in the scenario will ensure the user continues to enhance his knowledge. For example, if the user performs well on a scenario, the next scenario generated will be presented in the same manner, however the data contained within the scenario may be made more difficult to ensure the user's knowledge is enhanced. In another example, if the user performs poorly on a scenario, the next scenario generated will be presented in a different manner but the data contained with the scenario may be of the same level or slightly easier in order to determine the user's learning style. In another example, if the user performs ‘okay’ in on a scenario, the next scenario generated will be presented in a slightly modified manner and the data may be slightly made more difficult in order to further enhance the user's knowledge. Modification of the manner in which a scenario is presented will occur through the use of codified pedagogical principles. The selection of a particular pedagogical code will be made by the program, based upon the results of the feedback. The selection of specific data will be made by the program, based upon the results of the feedback. Both the particular pedagogical code and the specific data will be incorporated into the program during the generation of the next scenario.

FIG. 5 is an embodiment of the method of teaching a user with the present system, wherein a scenario is generated 501. The scenario is generated from the program of the system and based on data on the memory. The user interacts with the scenario 503, such interaction occurring via electronically enabled goggles. Through the goggles, a scenario is presented which includes a virtual environment and graphical tools. Biosensors are included on the goggles to measure the user's head movement and eye movement. Feedback is provided to the program as the user interacts with the scenario and the biosensors records the user's bodily functions. The feedback is analyzed 505 by comparing it against prior users feedback. The prior users feedback is stored on memory. A next scenario is generated 509, with the feedback analysis incorporated 509 to provide a next scenario based upon codified pedagogical principles and data.

FIG. 6 is an embodiment showing how feedback analysis affects future scenarios.

After receiving a scenario Z, and interaction by user, a feedback “Y” is presented to the program for analysis 601.

The feedback “Y” is analyzed by a measurement algorithm present on the program 603. The feedback and analysis will be incorporated into the program 605. In an alternative embodiment, the feedback and analysis can be stored on the memory. A scenario Z+1 will be generated 607, such scenario Z+1 reflecting a combination of;

program+pedagogical principle (X+1)+data

The pedagogical principle assist in generating the scenario Z+1 by altering the means and manner in which the program presents the scenario, i.e., the scenario will teach to the capability of the user, the scenario will add new ideas to well-known ideas, the scenario will focus on one main idea, the scenario will draw association between objects, the scenario will teach by occasioning the appropriate activity in the learner's mind, the scenario will expose the user to the best models in the field, the scenario will focus on the questions regarding the existence of similarity or difference among and within different views of common sense, etc. Following interaction with the user 609, a feedback Y+1 will be the result 611. The feedback Y+1 will be analyzed and incorporated into the program 613.

Scenarios can continue to be generated and responses collected and analyzed. Scenarios will progressively reflect the learning style of the user with the incorporated data representing the user well-known knowledge and new knowledge.

In general, the method of teaching using the present system occurs as follows: a scenario “Z” is generated for interaction with the user. A feedback “Y” will result, such feedback “Y” being analyzed by a measurement algorithm. Data collected from the feedback “Y” and analysis will be stored on the memory. A next scenario (Z+n) will be modified by a pedagogical principle (X) based upon the feedback analysis and specified to the learning style of the user. The user will interact with scenario (Z+n), and a feedback (Y+n) will result. The feedback (Y+n) will be analyzed. Data and the analysis will be stored on the memory, and a next scenario, (Z+n+1) will be modified by pedagogical principle (X+n) based upon the feedback analysis and specific to the learning style of the user. In the above description, “n” can be 1, 2, 3, 4, 5 or

In the above embodiments, through the incorporation of pedagogical algorithms into the scenario generated for interaction by the user, being modified by the response received from the user, further challenges will be continually specified to the users learning style and thus enhancing his learning experience.

### EXAMPLE

A system entitled the Fetal Monitoring Training and Learning Simulation is provided. The system is intended for users such as natal nurses, midwives, obstetricians, and medical school residents. The system is useful for teaching users how to monitor fetuses during birth and how to interpret normal and abnormal CTG data received from birth monitoring devices. On the Data Interface layer of the program of the system are stored historical CTG data. 3D models/characters, and learning outcomes database for storing response and feedback received from the user. At the Application Interface layer are mixed reality algorithms, codified pedagogical algorithms, algorithms that provide fetal monitoring challenges, algorithms that allow the measurement of the user's progress, and method of instruction algorithms.

Using user interface goggles and tactile gloves, a scenario is presented to a student from a 3D human-like digitized robot generated in a mixed reality environment. The 3D robot exhibits a technique to the student, and then poses a challenge to have the student repeat the technique. The performance (feedback) of the student and biosensor data are relayed back to the program for measurement and storage. The 3D robot exhibits another technique and presents a second challenge to the student. In this challenge, the 3D robot guides the student lesson as the challenge has been modified by the pedagogical algorithms contained on the program, and the challenge has been presented to be more appealing to the learning style of the student. After completion of this challenge, the feedback and biosensor data are sent back to the program, measured and stored. The 3D robot exhibits another technique, and presents a third challenge to the student. In this challenge, the 3D robot guides the student even less as the challenge has been modified further still by the pedagogical algorithms contained on the program, and the challenge has been presented to be even more appealing to the learning style of the student.

The presenting of challenges and their modification by codified pedagogical algorithms will continue until satisfactory completion of the scenario. As the Data Interface layer contains a database with historical CTG data, both normal and abnormal, the user will begin to experience abnormal CTG data in a realistic setting. By presenting abnormal CTG data and modification of challenges to appeal to the learning style of the student, his learning will be enhanced.

We claim:

1. A system for teaching a student comprising,
a memory with a program stored therein;
a user interface;
a processor;
and a power source;
wherein said program contains one or more codified pedagogical principles.

2. The system in claim 1, wherein said program comprises a data interface layer, an application interface layer, and a device interface layer.

3. The system in claim 2, wherein said program further comprises a wireless network layer.

4. The system in claim 1, wherein said memory contains stored scenarios.

5. The system in claim 1, wherein said codified pedagogical principles can be selected from the group consisting of scaffolding, weighted multi-modal instruction, personality based instruction, culturally tailored instruction.

6. The system in claim 5, wherein said codified pedagogical principles are codified according to a function selected from the group consisting of a logical-test; IF_TRUE; IF_FALSE function, a SUM function, an AVERAGE function, a MAX function, or a SUMIF function.

7. The system in claim 1, wherein the user interface may be selected from the group consisting of mouse, keyboard, screen, display, touchscreen, voice command recognition device, pointer system, goggles, robotic systems, electronically embedded headbands, electronically embedded wristbands, electronically enabled gloves, electronically enabled glasses, cellular phones, mobile phones, or PDA's.

8. The system in claim 7, further comprising biosensors.

9. The system in claim 1, wherein the user interface are electronically enabled goggles.

10. A method of enhancing the knowledge of a student with a system according to claim 1, comprising the steps of:
generating a scenario from a program;
facilitating interaction with said student;
delivering feedback to said program;
analyzing said feedback;
generating a next scenario; and
using analysis to modify said next scenario via codified pedagogical principles.

11. The method of claim 10, wherein generating a scenario involves passing data on a scenario from a data interface layer to an application interface layer.

12. The method of claim 10, wherein facilitating interaction with said student occurs within a graphically digitized environment.

13. The method of claim 12, wherein facilitating interaction with said student comprises exhibiting a particular technique to said student.

14. The method of claim 13, wherein facilitating interaction with said student comprises tutoring a student.

15. The method of claim 10, wherein delivering feedback to program occurs through wireless means.

16. The method of claim 10, wherein analyzing said feedback occurs by comparing said feedback to historical data stored on the memory.

17. The method of claim 10, wherein analyzing said feedback occurs by comparing said feedback to a standard stored on the memory.

18. The method of claim 10, wherein generating a next scenario involves passing data on a scenario from a data interface layer to an application interface layer.

19. The method of claim 10, wherein using analysis to modify said next scenario occurs through the use of pedagogical principles of data.

20. A system for enhancing the knowledge of a student, comprising,
a memory containing a program stored therein and scenarios, wherein said program contains one or more codified pedagogical principles, said pedagogical principles selected from the group consisting of the scaffolding, weighted multi-modal instruction, personality based instruction, and culturally tailored instruction;
electronically enabled goggles;
a processor;
one or more biosensors;
and a power source.
